(19) United States
(12) Patent Application Publication
(10) Pub. No.: US 2011/0032146 A1
(43) Pub. Date: Feb. 10, 2011

(54) Providing Positioning Assistance Data

(76) Inventors: Ismo Halivaara, Tampere (FI); Lauri Wirola, Tampere (FI); Jari Syrjärinne, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/988,644

(22) PCT Filed: Apr. 21, 2008
(86) PCT No.: PCT/EP2008/054825

§ 371 Date: Oct. 20, 2010

(51) Int. Cl. G01S 19/25

(52) U.S. Cl. 342/357.64

(57) ABSTRACT

For supporting the use of positioning assistance data, a positioning assistance server collects positioning assistance data from at least one mobile device and Provides the collected positioning assistance data for distribution to at least one other device.

### FIELD OF THE INVENTION

The invention relates in general to the field of assisted positioning. More particularly, the invention relates to the provision of positioning assistance data.

### BACKGROUND OF THE INVENTION

A position of a device can be determined by means of various positioning methods. Some of these methods may profit from the availability of assistance data.

A positioning of a device is supported for instance by various Global Navigation Satellite Systems (GNSS). These include for example the American Global Positioning System (GPS), the Russian Global Navigation Satellite System (GLONASS), the future European system Galileo, the Space Based Augmentation Systems (SBAS), the Japanese GPS augmentation Quasi-Zenith Satellite System (QZSS), the Locals Area Augmentation Systems (LAAS), and hybrid systems.

The constellation in GPS, for example, consists of more than 20 satellites that orbit the earth. Each of the satellites transmits two carrier signals L1 and L2. One of these carrier signals L1 is employed for carrying a navigation message and code signals of a standard positioning service (SPS). The L1 carrier phase is modulated by each satellite with a different C/A (Coarse Acquisition) code. Thus, different channels are obtained for the transmission by the different satellites. The C/A code is a pseudo random noise (PRN) code, which is spreading the spectrum over a 1 MHz bandwidth. It is repeated every 1023 bits, the epoch of the code being 1 ms. The carrier frequency of the L1 signal is further modulated with navigation information at a bit rate of 50 bit/s. The navigation information comprises inter alia ephemeris and almanac parameters. Ephemeris parameters describe short sections of the orbit of the respective satellite. Based on these ephemeris parameters, an algorithm can estimate the position of the satellite for any time while the satellite is in the respective described section. The almanac parameters are similar, but coarser orbit parameters, which are valid for a longer time than the ephemeris parameters. The navigation information further comprises for example clock models that relate the satellite time to the system time of GPS and the system time to the Coordinated Universal Time (UTC).

A GPS receiver of which the position is to be determined receives the signals transmitted by the currently available satellites, and it detects and tracks the channels used by different satellites based on the different comprised C/A codes. Then, the receiver determines the time of transmission of the code transmitted by each satellite, usually based on data in the decoded navigation messages and on counts of epochs and chips of the C/A codes. The time of transmission and the measured time of arrival of a signal at the receiver allow determining the pseudorange between the satellite and the receiver. The term pseudorange denotes the geometric distance between the satellite and the receiver, which distance is biased by unknown satellite and receiver offsets from the GPS system time. Moreover, pseudorange contains various error terms including troposphere and ionosphere delay as well as multipath.

In one possible solution scheme, the offset between the satellite and system clocks is assumed known and the problem reduces to solving a non-linear set of equations of four unknowns (3 receiver position coordinates and the offset between the receiver and GPS system clocks). Therefore, at least 4 measurements are required in order to be able to solve the set of equations. The outcome of the process is the receiver position.

Similarly, it is the general idea of GNSS positioning to receive satellite signals at a receiver which is to be positioned, to measure the pseudorange between the receiver and the respective satellite and further the current position of the receiver, making use in addition of estimated positions of the satellites. Usually, a PRN signal which has been used for modulating a carrier signal is evaluated for positioning, as described above for GPS.

In some environments, a GNSS receiver may be able to acquire and track sufficient satellite signals for a positioning based on the PRN codes, but the quality of the signals may not be sufficiently high for decoding the navigation messages. This may be the case, for instance, in indoor environments. Further, the decoding of navigation messages requires a significant amount of processing power, which may be limited in a mobile GNSS receiver.

Moreover, a satellite signal is distorted on its way from a satellite to a receiver due to, for instance, multipath propagation and due to influences by ionosphere and troposphere. While the GNSS satellites may transmit ionosphere models for correcting the signals accordingly, the provided models may be not very accurate or up-to-date.

If the GNSS receiver is included in a wireless communication terminal or attached as an accessory device to a wireless communication terminal, a wireless access network may therefore be able to provide the wireless communication terminal via a radio link with assistance data. Assistance data is typically provided for each satellite that is visible to the GNSS receiver associated to the cellular terminal. The assistance data may comprise navigation model parameters, which usually include orbit parameters, time of ephemeris (TOE) and time of clock (TOC) parameters and satellite identity parameters. Further, correction data which take account, for example, of GNSS signal delays caused by the atmosphere and the ionosphere, may be provided as assistance data. Such a supported GNSS based positioning is referred to as assisted GNSS (AGNSS). The received information enables the GNSS receiver or the associated wireless communication terminal to obtain a position fix in a shorter time, in more challenging signal conditions or more accurately.

Assistance data for assisted navigation systems, such as GNSSs like GPS, GLONASS and Galileo, have been specified and standardized for various cellular systems. The delivery of such assistance data can be built on top of cellular system-specific control plane protocols including, for example, the radio resource location services protocol (RRLP) for the Global System for Mobile Communications (GSM) networks, the radio resource control (RRC) layer of layer 3 in wideband code division multiple access (WCDMA) networks, and IS-801 for CDMA networks.

The Open Mobile Alliance (OMA) has moreover defined a user plane protocol referred to as secure user plane location (SUPL). SUPL employs user plane data bearers for transferring location assistance information such as GNSS assistance data and for carrying positioning technology-related protocols between terminal, for example a mobile communication device, and its operating network. SUPL is intended to be an alternative and, at the same time, a complement to the existing standards based on signaling in the mobile network control plane. SUPL assumes that a mobile or other network can establish a data bearer connection between a terminal and some type of location server. The use of a user plane protocol becomes especially appealing in case of internet protocol (IP) networks where the data bearer is available by nature.

### SUMMARY OF SOME EMBODIMENTS OF THE INVENTION

A method is described which comprises collecting positioning assistance data from at least one mobile device at a positioning assistance server, and providing the collected positioning assistance data for distribution to at least one other device.

Moreover, a first apparatus is described, which comprises a positioning assistance server. The positioning assistance server is configured to collect positioning assistance data from at least one mobile device. The positioning assistance server is further configured to provide the collected positioning assistance data for distribution to at least one other device.

The positioning assistance server could be implemented in hardware and/or software. A processor could for example execute software code for generating the positioning assistance server permanently or whenever required. It is to be understood that if the server is implemented in software, an apparatus has to be considered to comprise the defined positioning assistance server as well when the software is being executed as when the software is currently not being executed.

The described apparatus may consist for example exclusively of the positioning assistance server, but it may also comprise additional components. The apparatus could further be for example a module provided for integration into a device, like a processing component, a chip or a circuit implementing the positioning assistance server. Alternatively, the apparatus could be such a device itself. In the latter case, the apparatus could be for instance a network element, which comprises in addition an interface configured to enable a reception of data from mobile devices via a wireless communication network, or a mobile device, which comprises in addition an interface configured to enable a distribution of positioning assistance data to other devices.

Moreover, a second apparatus is described, which comprises means for enabling a positioning assistance server to collect positioning assistance data from at least one mobile device, and means for enabling the positioning assistance server to provide the collected positioning assistance data for distribution to at least one other device.

The means of this apparatus can equally be implemented in hardware and/or software. They may comprise for instance a processor for executing computer program code for realizing the positioning assistance server, a memory storing such program code, or both. Alternatively, the means could comprise for instance a circuit that is designed to realize the required functions, for instance implemented in a chipset or a chip, like an integrated circuit. It is to be understood that further means may be comprised which realize any of the functions that may optionally be implemented in any described embodiment of the first apparatus.

Moreover, a computer readable storage medium is described, in which computer program code is stored. When executed by a processor, the computer program code generates a positioning assistance server, which realizes the described method. The computer readable storage medium could be for example a disk or a memory or the like. The computer program code could further be stored in the computer readable storage medium in the form of instructions encoding the computer-readable storage medium. It is to be understood that also the computer program code by itself has to be considered an embodiment of the invention.

Thus, certain embodiments of the invention ensure that positioning assistance data can be provided by mobile devices via a positioning assistance server to other devices.

In one embodiment of the described method, the method comprises handling a registration of a mobile device with the positioning assistance server. The registration or login may be required only for devices to which the data is to be distributed, only for mobile devices from which data is to be collected, or both. In particular the first aspect may be useful for reasons of data protection and privacy. The mobile device providing the positioning assistance data may define for example, which other devices are allowed to receive the assistance data it provides. In particular the second aspect may be useful for determining at the server which kind of data the mobile devices are capable and willing to share.

In one embodiment of the described method, the method comprises receiving from a mobile device an indication of the content of the positioning assistance data that is to be collected from the mobile device. This can be realized for example in the scope of a registration of the mobile device. Alternatively, such an indication may be provided together with the provided positioning assistance data.

In one embodiment of the described method, the positioning assistance data is provided for distribution in a broadcast. It is to be understood, however, that a distribution using individual links between the server and a respective device could be employed just the same. A distribution in a broadcast could be implemented for instance in the scope of an Open Mobile Alliance Mobile Broadcast Services Enabler Suite (OMA BOAST) service. A distribution via individual links could be implemented for instance in the scope of the OMA SUPL.

In one embodiment of the described method, the method comprises providing in addition a service guide for distribution in a broadcast. The service guide indicates the content of the positioning assistance data that is provided in the broadcast. The content could be determined at the server based on a received indication from the mobile device providing the positioning assistance data or by evaluating the received assistance data.

In one embodiment of the described method, the positioning assistance data is provided for distribution in a user plane. By using a transmission on the user plane instead of on a control plane, a tight coupling with the employed radio bearer and/or network infrastructure, etc., can be avoided. It is to be understood, however, that a transmission on a control plane is not to be excluded.

In one embodiment of the described method, the positioning assistance data is provided for distribution in an internet protocol based transmission, even though other kinds of transmission, including circuit switched transmissions, could be employed just the same.

In one embodiment of the described method, the positioning assistance data comprises data having a limited validity. This positioning assistance data is collected and provided for distribution during the life-time of the positioning assistance data. The positioning assistance data in this case may be understood to be some kind of real-time assistance data. For instance, ephemeredes are typically valid for several hours, and this validity period may determine the time-frame in which they are provided for distribution as positioning assistance data.

In one embodiment of the described method, the positioning assistance data is collected from a plurality of mobile devices, the method further comprises merging the collected positioning assistance data before it is provided for distribution to at least one other device. The merging may comprise simply a combining of the collected data but equally a modification of the collected data.

In embodiments of the first described apparatus, the positioning assistance server may further be configured to realize any of the function described for embodiments of the described method. Corresponding functions can equally be realized by embodiments of the described computer program code when executed by a processor.

The positioning assistance data may be data that is valid for a small area, data that is valid for a larger area or data that is valid globally. Further, it may comprise data that supports an absolute positioning and/or data that enables a relative positioning of a receiving device, for example relative to the mobile device providing the data.

In one embodiment of the invention, the assistance data comprises positioning assistance data supporting a first fix of a position at a mobile device receiving the positioning assistance data. Such data may be suited to speed up the first fix at the mobile device receiving the positioning assistance data and/or to reduce the processing load at the mobile device receiving the positioning assistance data.

In addition or alternatively, the positioning assistance data may comprise for example high-accuracy measurements on received beacon signals. Such high-accuracy measurements may include for example carrier phase or code phase measurements, which enable a relative positioning of two devices with high precision.

In addition or alternatively, the positioning assistance data may comprise an indication reflecting ionosphere delays of satellite signals that are received at a mobile device from which positioning assistance data is collected. The indication reflecting ionosphere delays could comprise for example ionosphere correction values that can be applied directly to the time of reception of received satellite signals. Ionosphere delays originating from a single GNSS receiver are an example of assistance data that applies only to a small area, that is, they can be used only in a limited area around the location for which they have been produced. Ionosphere corrections values are readily available from multi-frequency satellite signal receivers, and if provided as assistance data, they enable nearby users with single-frequency satellite signal receivers to improve the quality of their satellite signal measurements. Compared to regional or global ionosphere models, which enable a corresponding correction, the amount of data that is to be transferred for an indication of ionosphere delays may be considerably smaller, but the quality of the corrections higher. Further, an indication of such delays might be directly applicable to signal measurements at the receiving device and not require extensive processing at the receiving device like ionosphere models.

Possible positioning assistance data for supporting for example a GNSS based positioning may comprise, but is not limited to, navigation models, time assistance, reference location, atmosphere models, differential corrections, sensor assistance and acquisition assistance, position information, high-accuracy position information, multi-frequency multi-GNSS measurement data, sensor measurements, route information and waypoint information.

In one embodiment of the first described apparatus, the apparatus further comprises a processor configured to generate positioning assistance data and to provide the generated positioning assistance data to the positioning assistance server. In case the positioning assistance server is generated by a processor, this may the same or a different processor.

In case the apparatus is a mobile device, which implements the positioning assistance server, the generated positioning assistance data could thus be positioning assistance data that is collected by the positioning assistance server. In case the apparatus is a stationary device which implements the positioning assistance server, the generated positioning assistance data could be positioning assistance data that is collected in addition by the positioning assistance server.

In another embodiment of the first described apparatus, which comprises again a processor configured to generate positioning assistance data, the apparatus further comprises a beacon signal receiver. The beacon signal receiver may be configured to receive beacon signals and to provide measurements on beacon signals to the processor as an input for the generation of positioning assistance data. Alternatively, such a beacon signal receiver could be linked to an embodiment of the first described apparatus for providing measurements on beacon signals to the processor.

In a variation of this embodiment of the described first apparatus, the beacon signal receiver is a multi-frequency satellite signal receiver. The processor may then be configured to generate positioning assistance data including an indication representing a ionosphere delay of received satellite signals, the ionosphere delay being determined based on multi-frequency measurements by the multi-frequency satellite signal receiver. The actual ionosphere delay or ionosphere correction values could be determined by the beacon signal receiver itself or by the processor.

In one embodiment of the invention, a method is an information providing method, comprising the actions of collecting positioning assistance data from at least one mobile device at a positioning assistance server, and providing the collected positioning assistance data for distribution to at least one other device.

In a further embodiment of the invention, an apparatus is an information providing apparatus comprising processing means for enabling a positioning assistance server to collect positioning assistance data from at least one mobile device, and processing means for enabling the positioning assistance server to provide the collected positioning assistance data for distribution to at least one other device.

In one embodiment of the invention, one of the described apparatuses can be seen as positioning assistance server apparatuses.

The invention can further be used for providing positioning assistance data for any kind of positioning, in particular, though not exclusively, for a satellite signal based positioning. Such satellite signals may comprise satellite signals transmitted in a GNSS, like GPS, GLONASS, GALILEO, SBAS, QZSS, LAAS or a combination of these. LAAS makes use of pseudolites instead of true satellites, but these pseudolites are to be understood to be covered as well by the term satellite as used in this application. LAAS has the advantage that it enables a positioning under indoor conditions as well. Examples of other positioning methods than GNSS based positioning methods comprise methods that are based on the location of access stations.

It is to be understood that any feature presented for a particular exemplary embodiment may also be used in combination with any other described exemplary embodiment.

Further, it is to be understood that the presentation of the invention in this section is merely exemplary and non-limiting.

Other objects and features of the present invention will become apparent from the following detailed description considered in conjunction with the accompanying drawings.

It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic diagram of a first exemplary system in which an embodiment of the invention is implemented;

FIG. 2 is a flow chart illustrating an exemplary operation in the system of FIG. 1;

FIG. 3 is a schematic diagram of a second exemplary system in which an embodiment of the invention is implemented;

FIG. 4 is a flow chart illustrating an exemplary operation in the system of FIG. 3;

FIG. 5 is a schematic diagram of a third exemplary system in which an embodiment of the invention is implemented; and

FIG. 6 is a flow chart illustrating an exemplary operation in the system of FIG. 5.

### DETAILED DESCRIPTION OF THE INVENTION

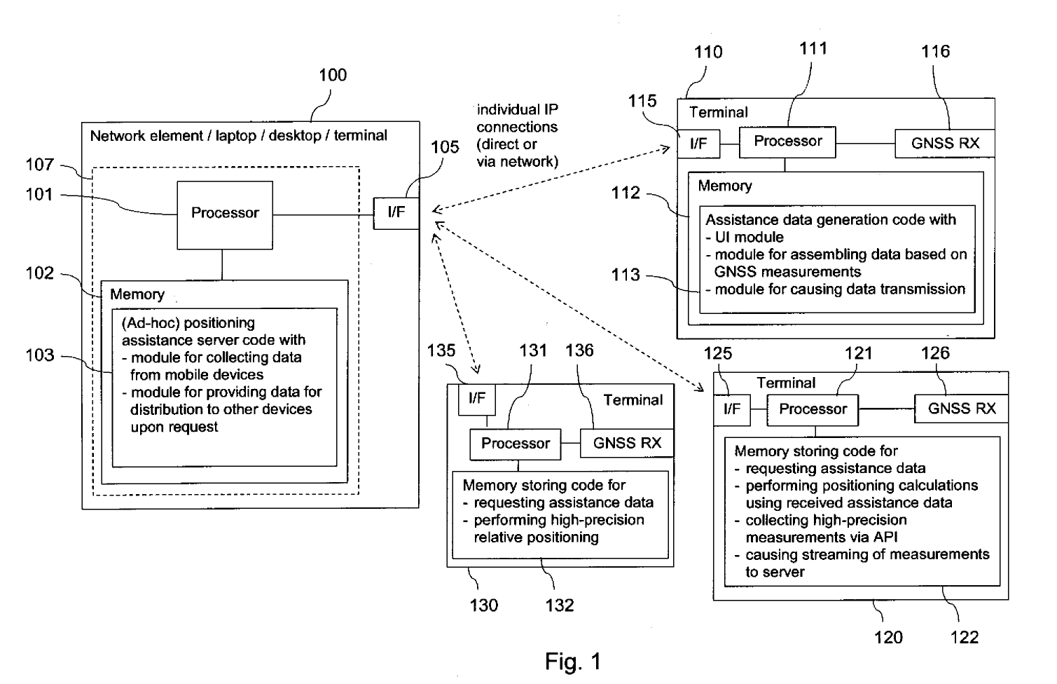

FIG. 1 is a schematic block diagram of a first exemplary system supporting the use of a positioning assistance server which manages assistance provided by mobile devices.

The system comprises a device 100, a first terminal 110, a second terminal 120 and a third terminal 130.

The device 100 could be for example a network element of a network, like the internet or a wireless communication network, but equally a laptop, a desktop computer or a mobile phone, etc. It comprises a processor 101 and, linked to this processor 101, a memory 102 and an interface 105 enabling a link to other devices. The processor 101 and the memory 102 could optionally be integrated in a single component 107 illustrated in FIG. 1 by dashed lines, for example on a chip.

The processor 101 is configured to execute implemented computer program code. The memory 102 stores computer program code that may be retrieved by the processor 101 for execution. The stored computer program codes comprise a positioning assistance server code 103 for generating a positioning assistance server, optionally an ad-hoc positioning assistance server that is only generated on demand. The code 103 includes in this scope a functional module for collecting data from mobile devices and a functional module for distributing collected data to other devices. The memory 103 can thus be seen as an embodiment of a computer readable storage medium according to the invention.

The interface 105 may provide a direct link to mobile terminals 110, 120, 130 or an indirect link, for example via the internet and a wireless communication network. The interface 105 may support for example IP connections carrying location protocols, such as OMA SUPL.

The first terminal 110 can be for example a mobile phone or some other mobile device. It comprises a processor 111 and, linked to this processor 111, a memory 112, an interface 115 enabling a link to other devices, a GNSS receiver (RX) 116 and a user interface (UI) (not shown). The processor 111 and the memory 112 could optionally be integrated in a single component, for example on a chip.

The processor 111 is configured to execute implemented computer program code. The memory 112 stores computer program codes, which may be retrieved by the processor 111 for execution. The stored computer program codes comprise an assistance data generation code 113, including a functional module for supporting a user interaction, a functional module for assembling assistance data based on GNSS measurements received from the GNSS receiver 116, and a functional module for causing transmission of the generated assistance data to a positioning assistance server.

The interface 115 may enable a direct link to device 100 or an indirect link, for example via a wireless communication network. The interface 115 may support for example IP connection, like carrying location protocols, such as OMA SUPL. The interface 115 could be for example a transceiver belonging to a cellular engine of the terminal 110 and support an access to a cellular communication network, or it could belong to a WLAN engine of the terminal 110 and support an access to a WLAN. Alternatively, it could support wireless links using any other kind of technology.

The user interface may provide input and/or output functionality. It could comprise for example keys, a touchpad, a display, loudspeakers, etc.

The GNSS receiver 116 may be integrated in the terminal 110. Alternatively, though, it could also be or belong to an accessory device that is connected to the terminal 110. The GNSS receiver 116 may be configured to operate as a normal GNSS receiver. That is, it is configured to receive, acquire, track and decode signals transmitted by satellites belonging to one or more GNSSs, like GPS and Galileo. Based on the navigation information in the decoded signals and on measurements on the received signals, it may further able to compute its position and velocity, etc.

The second terminal 120 can equally be for example a mobile phone or some other mobile device. It may have the same components as the first terminal 110, including a processor 121, a memory 122, an interface 125, a GNSS receiver 126 and a user interface UI.

In this case, the memory 122 may store computer program codes which comprise a positioning and assistance data generation code, including a functional module for requesting assistance data, a functional module for supporting an acquisition of GNSS measurements at the GNSS receiver 126, a functional module for collecting high-precision measurements, and a functional module for causing a streaming of the high-precision measurements to a positioning assistance server.

The third terminal 130 can equally be for example a mobile phone or some other mobile device. It may have the same components as the first terminal 110, including a processor 131, a memory 132, an interface 135, a GNSS receiver 136 and a user interface UI.

In this case, the memory 132 may store computer program code which comprise a positioning code, including a functional module for requesting assistance data from a server and a functional module for performing a high precision relative positioning based on received assistance data and based on GNSS measurements received from GNSS receiver 136.

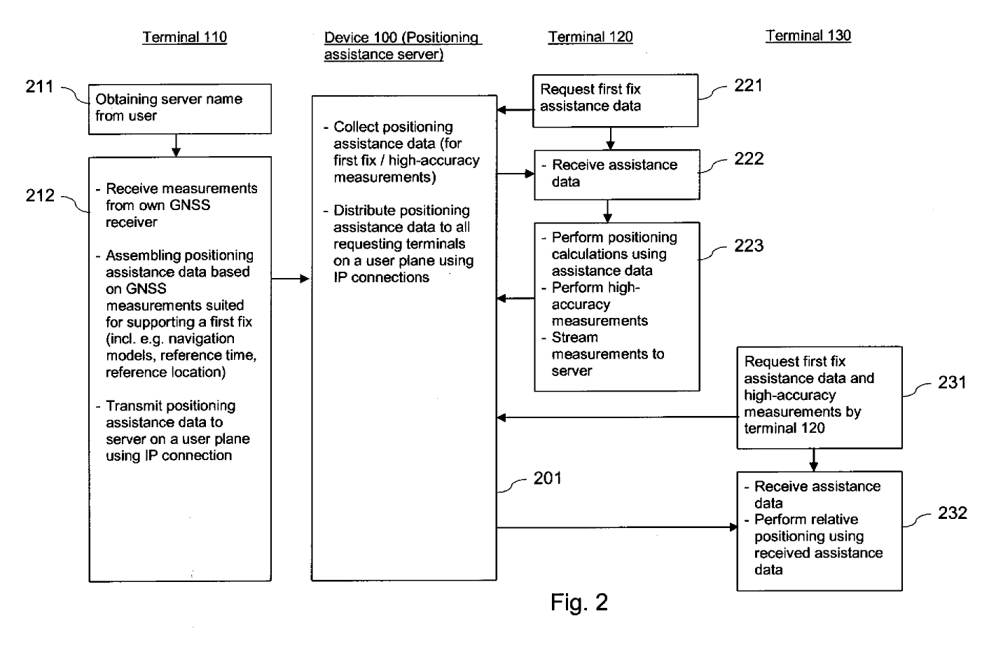

An exemplary operation in the system of FIG. 1 is illustrated in the flow chart of FIG. 2.

FIG. 2 presents from left to right an operation at the first terminal 110, an operation at device 100, an operation at second terminal 120 and an operation at third terminal 130.

In the exemplary operation, each of the terminals 110, 120, 130 performs different functions. Summarized, terminal 110 is the backbone of an ad-hoc network between the terminals 110, 120, 130 and a positioning assistance server provided by device 100. It provides conventional AGNSS assistance data, including navigation models etc. for first-fix purposes, to the server for distribution to terminals 120 and 130. Terminal 120 provides in addition high-accuracy measurements to the server for delivery to terminal 130 to enable terminal 130 to determine its position exactly relative to terminal 120.

A user of terminal 110 who wishes to distribute positioning assistance data to other devices may cause the processor 111 via the user interface to execute the assistance data generation code 113.

The processor 111 uses the user interface module of assistance data generation code 113 for prompting the user to enter the name of a server via which the data is to be distributed (action 211). The name may also correspond to a name that is associated to device 100 implementing this server.

In the following, assistance data is generated and transmitted, until the process is stopped again by the user (action 212).

In this process, the processor 111 uses the appropriate functional module of the assistance data generation code 113 for obtaining and assembling various data provided by the GNSS receiver 116. The assembled data comprises positioning assistance data that is suited for supporting a first fix of other devices. The data may include for instance a reference time, a reference location and navigation models. The reference location may be received from GNSS receiver 116 or be computed by processor 111 based on raw measurements received from GNSS receiver 116.

The processor 111 uses the appropriate functional module of the assistance data generation code 113 for causing a transmission of the assembled positioning assistance data to an address identified by the name input by the user.

The data is transmitted via interface 115 to device 100, for example on the user plane using an IP connection.

In device 100, the positioning assistance data is received via interface 105 and provided to a positioning assistance server.

The positioning assistance server may always be active, or it may be activated ad-hoc upon receipt of positioning assistance data by a terminal.

The processor 101 uses the positioning assistance server code 103 for realizing the functions of the positioning assistance server (action 201).

The processor 101 uses the appropriate functional module of server code 103 for continuously collecting positioning assistance that is received at device 100 from a terminal 110, and for assembling the collected positioning assistance data for distribution. When assembling the positioning assistance, the processor 101 may take care that only up-to-date data is provided for distribution.

The processor 101 uses the appropriate functional module of server code 103 for distributing the assembled data to other terminals upon their request on a user plane using individual IP connections.

For example, the processor of terminal 120 may use the appropriate functional module of an available code for requesting from the server positioning assistance data for a first fix (action 221). This can be for instance a request that is transmitted by default whenever a positioning is to be performed, a request that is transmitted upon a corresponding user input, or a request that is generated and transmitted automatically when the current satellite signal reception conditions seem to make such a request desirable.

The terminal 120 receives thereupon from the positioning assistance server of device 100 corresponding assistance data for a first fix (action 222).

The terminal 120 may then use the received assistance data for supporting an acquisition of satellite signals at GNSS receiver 126 and/or for reducing the processing load in extracting navigation data from received signals, etc. The received assistance data may be provided to this end to GNSS receiver 126.

The processor 121 executing program code stored in memory 122 may then receive from the GNSS receiver 126 for instance a determined current position of terminal 120. In case the user of terminal 120 does not only wish to determine the actual position of terminal 120, but in addition to support an accurate positioning of terminal 130 relative to terminal 120, the processor 121 uses a stored functional module for retrieving from the GNSS receiver 126 moreover high-accuracy measurements of the acquired signals, for example carrier and/or code phase measurements.

The processor 121 executing program code stored in memory 122 further causes a streaming of the high-precision measurements, and possibly in addition the determined position, to device 100 via interface 125 (action 223).

The processor 101 of device 100 uses the functional module for collecting data of server code 103 also for collecting this positioning assistance data from terminal 120, and the functional module for providing data for distribution for distributing this data upon request of some other device (action 201).

The user of terminal 130 may now cause the processor 131 via a user interface to execute a code stored in memory 132 for requesting positioning assistance data for a relative positioning (action 231). The user of terminal 130 may wish for instance to know only a relative position of terminal 130 to terminal 120.

The terminal 130 receives thereupon from the positioning assistance server of device 100 corresponding assistance data for a first fix provided by terminal 110 and high-accuracy measurements provided by terminal 120 (action 232). The processor 131 may provide the assistance data for a first fix to GNSS receiver 136 for supporting an acquisition of satellite signals and request high-accuracy measurements for the acquired satellite signals.

Based on the received high-accuracy measurements from the own GNSS receiver 136 and from the GNSS receiver 126 of terminal 120, the processor 131 of terminal 130 may then determine a highly accurate position relative to terminal 120 by executing corresponding stored program code. In case the absolute position of terminal 120 is provided in addition in the assistance data, the processor 131 may also determine its own absolute position.

In particular terminals 120 and 130 might be required to register or log on with the positioning assistance server of device 100 for reasons of data protection and privacy, since the data provided by terminal 120 would enable any other terminal to determine its relative position with high accuracy. This might only be desired for certain terminals. By means of a registration, the users providing positioning assistance data for distribution are able to control how the server utilizes the capabilities of user's terminal.

It might be noted that an application programming interface (API) could be provided for enabling various applications to access raw measurements and other data that are provided by a GNSS receiver. Any application could then comprise the described functional modules for forwarding the data to a positioning assistance server. Alternatively, an application could be provided that is able to directly access raw measurements and other data provided by the GNSS receivers.

Similarly, an API might be provided for feeding positioning assistance data that is received from a positioning assistance server to an application using this data, for example a position calculation entity. Alternatively, an application could be provided that is able to receive positioning assistance data from a server directly.

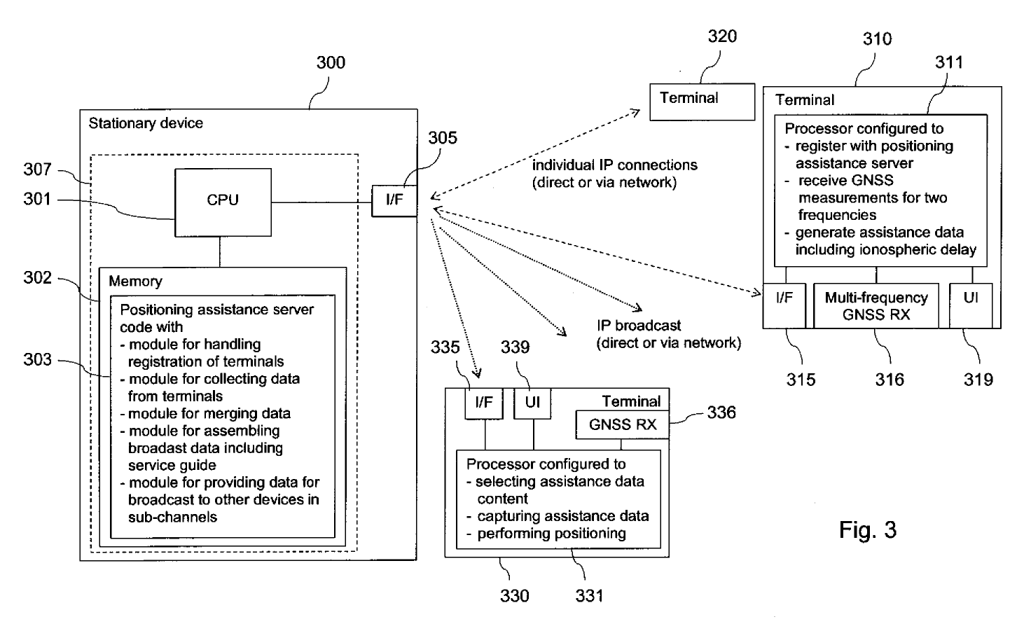

FIG. 3 is a schematic block diagram of a second exemplary system supporting the use of a positioning assistance server, which manages assistance provided by mobile devices.

The system comprises again a device 300, a first terminal 310, a second terminal 320 and a third terminal 330.

The device 300 could be for example a network element of a network, like the Internet or a wireless communication network, but equally a laptop, a desktop computer or a mobile terminal, etc. It comprises a central processing unit (CPU) 301 and, linked to this CPU 301, a memory 302 and an interface 305 enabling individual links to mobile devices as well as a broadcast of data to mobile devices. The CPU 301 and the memory 302 could optionally be integrated in a single component 307 illustrated in FIG. 3 by dashed lines, for example on a chip.

The CPU 301 is configured to execute implemented computer program code. The memory 302 stores computer program code, which may be retrieved by the CPU 301 for execution. The stored computer program codes comprise a positioning assistance server code 303 for generating a positioning assistance server, optionally an ad-hoc positioning assistance server that is only generated on demand. The code 303 includes in this scope a functional module for handling a registration of terminals, a functional module for collecting data from mobile devices, a functional module for merging assistance data from several mobile devices, a functional module for assembling broadcast data including a service guide, and a functions module for providing the assembled data for a broadcast to other devices in different sub-channels. The memory 303 can thus be seen as a further embodiment of a computer readable storage medium according to the invention.

The interface 305 may enable a direct link to mobile devices or an indirect link, for example via the Internet and a wireless communication network. The interface 305 may support to this end for example IP connections carrying location protocols, such as OMA SUPL. Similarly, the interface 305 may enable a direct broadcast to mobile terminals or an indirect broadcast, for example via the internet and a wireless communication network. The interface 305 may support to this end for example a user plane IP broadcast, like OMA BCAST.

The first terminal 310 can be for example a mobile phone or some other mobile device. It comprises a processor 311 and, linked to this processor 311, an interface 315 enabling a link to other devices, a multi-frequency multi-GNSS receiver 316 and a user interface 319.

The processor 311 is configured to realize various functions, for example by executing corresponding computer program code. Such computer program code may be retrieved by the processor 311 for execution from a processor-internal or -external memory (not shown). The stored computer program codes comprise functional modules for handling a registration with a positioning assistance server, for receiving GNSS measurements for two frequencies, and for generating and transmitting assistance data including a ionosphere delay. It is to be understood that a separate code for an application programming interface may be provided for any interaction with the GNSS receiver 316 if desired, and that separate code for supporting a user interaction via the user interface 319 may be provided if desired.

The interface 315 may enable a direct link to device 300 or an indirect link, for example via a wireless communication network. The interface 315 may support for example IP connections carrying location protocols, such as OMA SUPL. The interface 315 could be for example a transceiver belonging to a cellular engine of the terminal 310 and support an access to a cellular communication network, or it could belong to a WLAN engine of the terminal 310 and support an access to a WLAN. Alternatively, it could support wireless links using any other kind of technology.

The user interface may provide input and/or output functionality. It could comprise for example keys, a touchpad, a display, loudspeakers, etc.

The multi-GNSS receiver 316 may be integrated in the terminal 310. Alternatively, though, it could also be or belong to an accessory device that is connected to the terminal 310. The GNSS receiver 316 may be configured to operate as a normal GNSS receiver. However, it is designed to support reception of satellite signals at least at two frequencies, by way of example two frequencies of two different GNSSs. That is, it is configured to receive, acquire, track and decode signals transmitted by satellites belonging to two GNSSs, like GPS and Galileo. Based on measurements at two frequencies, it may be able to determine ionosphere correction values. Based on the navigation information in the decoded signals and based on measurements on the received signals, it may further able to compute its position and velocity, etc.

The second terminal 320 can be implemented for example in exactly the same way as terminal 310.

The third terminal 330 can equally be for example a mobile phone or some other mobile device. It may have again the same components as the first terminal 330, including a processor 331, an interface 335, a GNSS receiver 336 and a user interface UI 339.

In this case, implemented computer program codes that can be executed may comprise a functional module for selecting broadcast assistance data content and a positioning module.

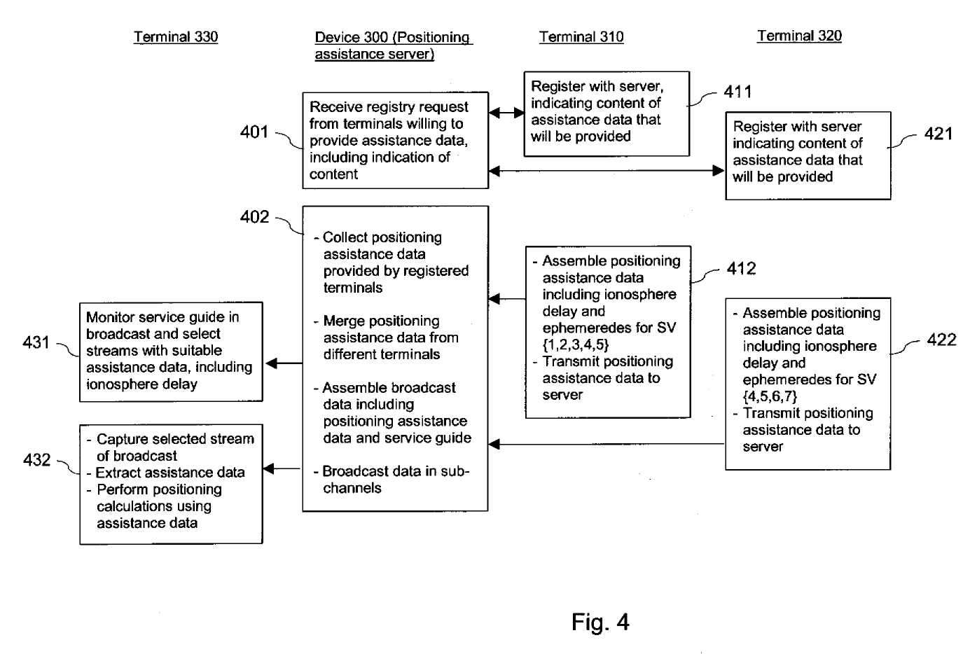

An exemplary operation in the system of FIG. 3 is illustrated in the flow chart of FIG. 4.

FIG. 4 presents from left to right an operation at terminal 330, an operation at the positioning assistance server of device 300, an operation at terminal 310 and an operation at terminal 320.

A user of terminal 310 who wishes to distribute positioning assistance data may cause the processor 311 via the user interface 319 to run a corresponding application. Using functional modules of this application, the processor 311 may prompt the user to enter the name of a server via which the data is to be distributed. It is to be understood that this prompting may include the offer to select a stored server name. The processor 311 then causes a registration of the terminal 310 with the indicated server (action 411). The data that is transmitted to this end via interface 315 to device 300 may include an indication of the content of the assistance data that will be provided. The user of terminal 310 may be willing, for example, to provide specifically ephemeredes and ionosphere correction values. Alternatively, the processor 311 could transmit for instance an identification of terminal 310 to enable the device 300 to determine a stored indication of content that is generally provided by terminal 310. Exactly the same actions may be performed by terminal 320 (action 421).

In device 300, the registration request from both terminals 310, 320 and the associated indication of content are received via interface 305 by a positioning assistance server that is provided by CPU 301 when executing positioning assistance server code 303 (action 401). The positioning assistance server may be active constantly or only upon trigger by received registration data from terminals.

If desired, there could be a feedback from the CPU 301 to the terminals 310, 320 to indicate whether the registration was successful. The CPU 301 may use to this end the corresponding functional module of code 303.

The processor 311 of terminal 310 then causes the GNSS receiver 316 to provide ephemeredes for all visible satellites and ionosphere correction values that are determined by GNSS receiver 316 based on multi-frequency GNSS measurements. Alternatively, the processor 311 could cause the GNSS receiver 316 to provide multi-frequency GNSS measurements and determine the ionosphere correction values based on these measurements itself.

The processor 311 further assembles positioning assistance data including ephemeredes for exemplary satellites {1, 2, 3, 4, 5}, the ionosphere correction values and optionally additional data. Such additional data could comprise an indication of the position of the terminal 310 to define the area of validity of the ionosphere correction data. The assembled positioning assistance data is then provided by processor 311 for transmission via interface 315 to device 300 (action 912).

The same assembly and transmission of positioning assistance data is performed by terminal 320 (action 422). In this case, the positioning assistance data may include for example ephemeredes for exemplary satellites {4, 5, 6, 7}.

The CPU 301 of device 300 uses the appropriate functional module of code 303 for collecting the positioning assistance data that is provided by all registered terminals. It further uses the appropriate functional module of code 303 for merging the positioning assistance data from different terminals, if feasible. For example, the provided ephemeredes for satellites {1, 2, 3, 4, 5} and the provided ephemeredes for satellites {4, 5, 6, 7} can be combined to ephemeredes for all involved satellites {1, 2, 3, 9, 5, 6, 7}.

The CPU 301 then uses the appropriate functional module of code 303 for assembling broadcast data that includes the actual positioning assistance data and a service guide. Different content of the positioning assistance data may be provided in different streams, and the service guide may be provided as a further stream. The service guide includes an indication which content of the positioning assistance data is provided in which stream.

The data is then provided by CPU 301, using a corresponding functional module of code 303, for a broadcast in separate streams via interface 305 and thus in different sub-channels that may be captured separately by receiving terminals (action 402).

Processor 331 of terminal 330, for example, may cause the terminal 330 to monitor the service guide in a broadcast by device 300 and to select streams with suitable assistance data (action 431). Terminal 330 may look for instance specifically for ionosphere correction values in the broadcast, since its GNSS receiver 336 is no multi-frequency receiver so that it is not able to produce ionosphere correction values by itself.

The processor 331 captures the selected stream of the broadcast and extracts the assistance data from the stream. An API may be generated by processor 331 for providing the received data to a positioning application, which performs positioning calculations using data from GNSS receiver 336 and in addition the received ionosphere correction values.

It is to be understood that CPU 301 could also collect data from any additional source providing positioning assistance data. Such additional data could then equally be merged with the data provided by different terminals, before the entire available positioning assistance data is provided for distribution.

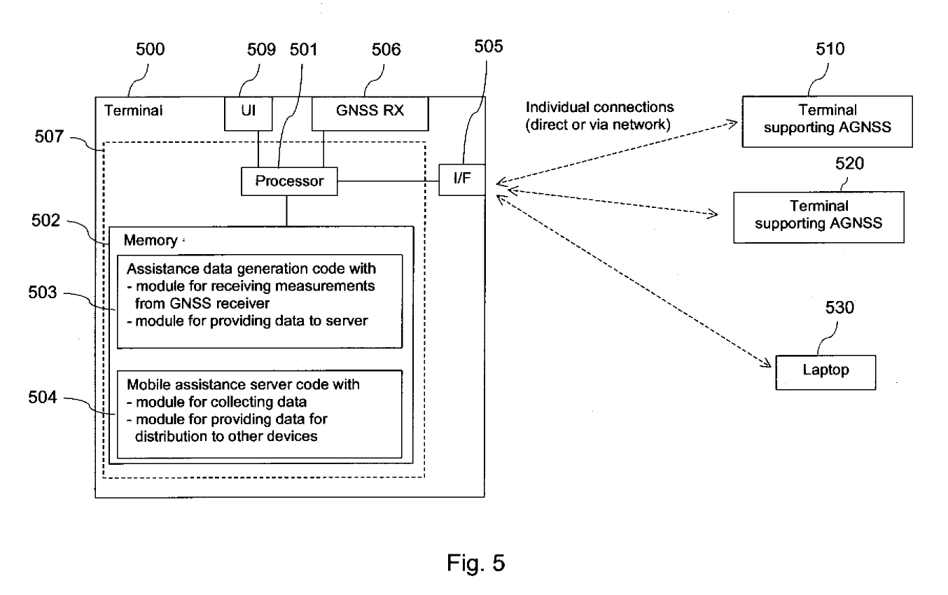

FIG. 5 is a schematic block diagram of a third exemplary system supporting the use of a positioning assistance server which manages assistance provided by mobile devices.

The system comprises a first terminal 500, a second terminal 510 supporting AGNSS, a third terminal 520 supporting AGNSS and a laptop 530.

Terminal 500 could be for example a mobile terminal, but equally any other kind of mobile device with communication capabilities. It comprises a processor 501 and, linked to this processor 501, a memory 502, an interface 505 enabling an exchange of data with other devices, a GNSS receiver 506 and a user interface 509. The processor 501 and the memory 502 could optionally be integrated in a single component 507 illustrated in FIG. 5 by dashed lines, for example on a chip.

The processor 501 is configured to execute implemented computer program code. The memory 502 stores computer program code, which may be retrieved by the processor 501 for execution. The stored computer program codes comprise an assistance data generation code 503. The code 503 includes in this scope a functional module for receiving measurements from the GNSS receiver 506 and a functional module for providing the measurements to a mobile assistance server. The stored computer program codes moreover comprise a positioning assistance server code 504 for generating this mobile assistance server. This code 504 includes a functional module for collecting data and a functional module for providing collected data for distribution to other devices. The memory 502 can thus be seen as a further embodiment of a computer readable storage medium according to the invention.

The interface 505 may enable a direct link to devices 510, 520, 530 or an indirect link, for example via the internet and a wireless communication network. The interface 505 may support for example IP connections.

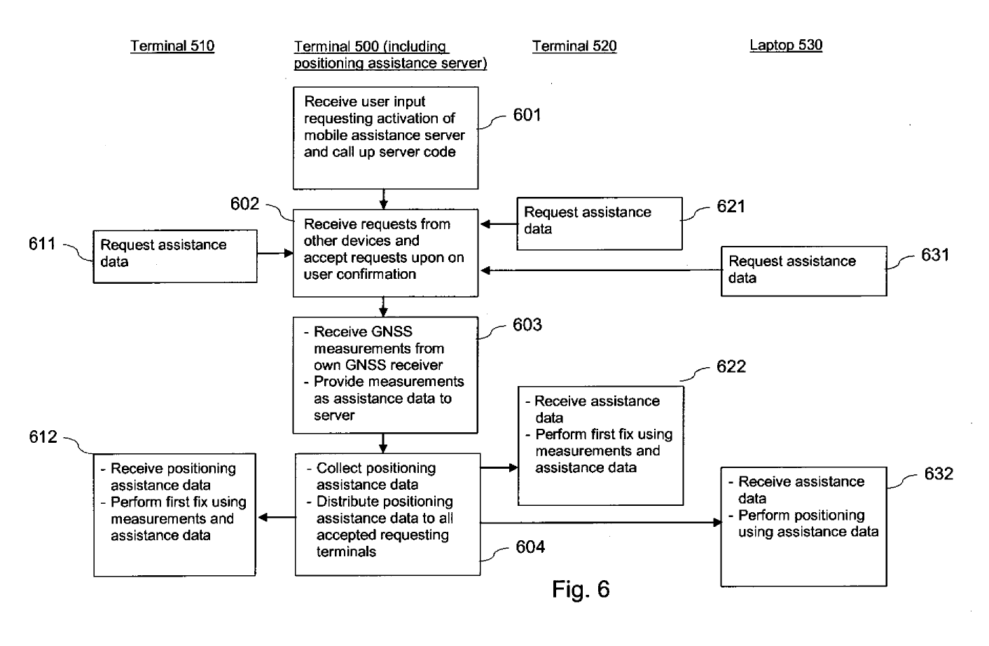

An exemplary operation in the system of FIG. 5 is illustrated in the flow chart of FIG. 6.

FIG. 6 presents from left to right an operation at terminal 510, an operation at terminal 500, an operation at terminal 520 and an operation at laptop 530.

Terminal 500 may receive a user input via user interface 509 which requests an activation of the mobile assistance server, causing the processor 501 to call up the server code 504 and the data generation code 503 (action 601).

Each of terminal 510, terminal 520 and laptop 530 may moreover request positioning assistance data from terminal 500 (actions 611, 621 and 631).

Processor 501 executing code 504 receives the requests via interface 505 and accepts the request from each device upon user confirmation via user interface 509 (action 602). This action may also be considered some kind of registration of the requesting devices 510, 520, 530. Further, instead of asking for a user confirmation upon each request, it would be possible for example to enable the user to store and update identifiers of certain devices, of which a request is to be accepted automatically.

Processor 501 executing code 503 receives in the meantime GSNS measurements from its own GNSS receiver 506 using the corresponding functional module.

Processor 501 executing code 503 moreover provides the received raw measurements to executed code 504 realizing the mobile assistance server using the corresponding functional modules (action 603).

Processor 501 executing code 504 and using the appropriate functional module collects and assembles the received positioning data for distribution. Further, the processor 501 using an appropriate functional module of server code 504 takes care that the positioning assistance data is distributed via interface 505 over individual links to all terminals of which a request for assistance data has been accepted in action 602 (action 604).

The terminals 510 and 520 receive the positioning assistance data and uses the received data for an assisted positioning, for instance for speeding up the first fix by avoiding the need to extract all the navigation information from the satellite signals received by the own GNSS receivers (actions 612, 622).

Also laptop 530 receives the positioning assistance data and may use the received data in some kind of positioning calculations (action 632).

Certain embodiments of the invention thus allow a terminal user to act as a content provider, that is, to produce data that is distributed to other devices to assist them in positioning procedures. An adaptation of the positioning assistance data provider to a proprietary interface of an assistance data server, or vice versa, is not required.

In some embodiments of the invention, the assistance infrastructure can be set up at minimal cost using minimal hardware—possibly nothing more than a mobile terminal with AGNSS-capability and a mobile server. The assistance produced in this environment can be either global (at least very large scale) or on the other hand very local (for instance, measurement corrections).

Some embodiments also allow individual mobile devices to register with a positioning assistance server before providing content to the assistance server so that true locality can be introduced to location assistance.

Certain embodiments of the invention also allow setting up a small scale assistance data server for e.g. a limited user group. The provided assistance data may be tailor made to a very restricted geographical area without requiring an excessive amount of network infrastructure. Assistance data could be distributed within a closed group in an ad-hoc network or via public Internet. Small scale assistance data solutions might be utilized for example by assistance sharing communities that share assistance data among its members. For instance, the community members, who are by definition willing to share assistance data, get access to assistance data shared by other community members.

Any presented link or connection in this document is to be understood in a way that the involved components are operationally coupled. Thus, the connections can be direct or indirect with any number or combination of intervening elements, and there may be merely a functional relationship between the components.

Further, any of the mentioned processors and processing units could be of any suitable type, for example a computer processor, field-programmable gate arrays, an application-specific integrated circuit (ASIC), etc. Any of the mentioned memories could be implemented as a single memory or as a combination of a plurality of distinct memories, and may comprise for example a read-only memory, a flash memory or a hard disc drive memory, etc. Furthermore, any other hardware components that have been programmed in such a way to carry out the described functions could be employed as well.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as field-programmable gate arrays, application-specific integrated circuits (ASICs), signal processing devices, and other devices.

The functions illustrated by processor/CPU 101, 301, 501 and/or memory 102, 302, 502 and/or module 107, 307, 507 can also be viewed as means for enabling a positioning assistance server to collect positioning assistance data from at least one mobile device, and as means for enabling the positioning assistance server to provide the collected positioning assistance data for distribution to at least one other device.

The program codes 103, 303 and 503 can also be viewed as comprising such means in the form of functional modules.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method actions which perform substantially the same function in substantially the same way to achieve the same results are within the scope of the invention. Moreover, it should be recognized that structures and/or elements and/or method actions shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures.

1. A method comprising:
collecting, by an apparatus, positioning assistance data from at least one mobile device, the apparatus being or belonging to a device that is different from the at least one mobile device; and
providing, by the apparatus, the collected positioning assistance data for distribution to at least one other device for supporting a positioning of the at least one other device.

2. (canceled)

3. The method according to claim 1 further comprising:
receiving from a mobile device an indication of the content of the positioning assistance data that is to be collected from the mobile device.

4. (canceled)

5. (canceled)

6. The method according to claim 1, wherein the positioning assistance data is provided for distribution in a user plane.

7. The method according to claim 1, wherein the positioning assistance data is provided for distribution in an internet protocol based transmission.

8. The method according to claim 1, wherein the positioning assistance data comprises data having a limited validity and wherein positioning assistance data is collected and provided for distribution during the life-time of the positioning assistance data.

9. The method according to claim 1, wherein the positioning assistance data is collected from a plurality of mobile devices, the method further comprising:
merging the collected positioning assistance data before it is provided for distribution to at least one other device.

10. The method according to claim 1, wherein the assistance data comprises at least one of
positioning assistance data supporting a first fix of a position at a mobile device receiving the positioning assistance data;
high-accuracy measurements on received beacon signals;
a navigation model;
time assistance;
reference location;
an atmosphere model;
differential corrections;
sensor assistance;
acquisition assistance;
position information;
multi-frequency multi global navigation satellite system measurement data;
sensor measurements;
route information; and
waypoint information.

11. An apparatus comprising at least one processor and at least one memory including computer program code, the at least one memory and the computer program code configured to, with the at least one processor, cause the apparatus at least to perform:
collect positioning assistance data from at least one mobile device, the apparatus being or belonging to a device that is different from the at least one mobile device; and
provide the collected positioning assistance data for distribution to at least one other device.

12. (canceled)

13. The apparatus according to claim 11, wherein the at least one memory and the computer program code are configured to, with the at least one processor, cause the apparatus to receive from a mobile device an indication of the content of the positioning assistance data that is to be collected from the mobile device.

14. (canceled)

15. The apparatus according to claim 11, wherein the positioning assistance data is provided for distribution in a broadcast, and wherein the at least one memory and the computer program code are configured to, with the at least one processor, cause the apparatus to provide in addition a service guide for distribution in the broadcast, the service guide indicating the content of the positioning assistance data that is to be provided in the broadcast, wherein different content is provided in different streams and the service guide is provided in a further stream.

16. The apparatus according to claim 11, wherein the at least one memory and the computer program code are configured to, with the at least one processor, cause the apparatus to provide the positioning assistance data for a distribution in a user plane transmission.

17. The apparatus according to claim 11, wherein the at least one memory and the computer program code are configured to, with the at least one processor, cause the apparatus to provide the positioning assistance data for distribution in an internet protocol based transmission.

18. The apparatus according to claim 11, wherein the positioning assistance data comprises data having a limited validity and wherein the at least one memory and the computer program code are configured to, with the at least one processor, cause the apparatus to collect positioning assistance data and to provide it for distribution during the life-time of the positioning assistance data.

19. The apparatus according to claim 11, wherein the at least one memory and the computer program code are configured to, with the at least one processor, cause the apparatus to merge the collected data before it is provided for distribution to at least one other device, in case the positioning assistance data is collected from a plurality of mobile device.

20. The apparatus according to claim 11, wherein the assistance data comprises at least one of
positioning assistance data supporting a first fix of a position at a mobile device receiving the positioning assistance data;
high-accuracy measurements on received beacon signals;
a navigation model;
time assistance;
reference location;
an atmosphere model;
differential corrections;
sensor assistance;
acquisition assistance;
position information;
multi-frequency multi global navigation satellite system measurement data;
sensor measurements;
route information; and
waypoint information.

21. The apparatus according to claim 11, wherein the at least one memory and the computer program code are configured to, with the at least one processor, cause the apparatus to generate additional positioning assistance data.

22. (canceled)

23. The apparatus according to claim 21, further comprising a multi-frequency satellite signal receiver, wherein the at least one memory and the computer program code are configured to, with the at least one processor, cause the apparatus to generate positioning assistance data which comprises an indication reflecting a ionosphere delay of received satellite signals, the ionosphere delay being determined based on multi-frequency measurements by the multi-frequency satellite signal receiver.

24. The apparatus according to claim 11, wherein the apparatus is one of a network element, a desktop computer and a mobile device.

25. (canceled)

26. A non-transitory computer readable storage medium in which computer program code is stored, the computer program code causing an apparatus to realize the following when executed by a processor:
collecting positioning assistance data from at least one mobile device, the apparatus being or belonging to a device that is different from the at least one mobile device; and
providing the collected positioning assistance data for distribution to at least one other device for supporting a positioning of the at least one other device.

27. (canceled)

28. (canceled)

29. (canceled)

30. (canceled)

31. (canceled)

32. (canceled)

33. (canceled)

34. (canceled)

35. (canceled)

36. The method according to claim 1, wherein the assistance data comprises at least an indication reflecting a ionosphere delay of satellite signals at a mobile device from which positioning assistance data is collected.

37. The apparatus according to claim 11, wherein the assistance data comprises at least an indication reflecting a ionosphere delay of satellite signals at a mobile device from which positioning assistance data is collected.
